(19) United States
(12) Patent Application Publication
(10) Pub. No.: US 2025/0129497 A1
(43) Pub. Date: Apr. 24, 2025

(54) CATALYST, CATHODE, ION EXCHANGE MEMBRANE-ELECTRODE ASSEMBLY AND SOLID ELECTROLYTE ELECTROLYSIS APPARATUS

(71) Applicant: IDEMITSU KOSAN CO.,LTD., Tokyo (JP)

(72) Inventors: Hiroyuki KANEKO, Funabashi-shi (JP); Qingxin JIA, Kisarazu-shi (JP)

(73) Assignee: IDEMITSU KOSAN CO.,LTD., Tokyo (JP)

(21) Appl. No.: 18/835,607

(22) PCT Filed: Feb. 22, 2023
(86) PCT No.: PCT/JP2023/006463

§ 371 Date: Aug. 2, 2024

(30) Foreign Application Priority Data
Feb. 28, 2022 (JP) 2022-029887

(51) Int. Cl. C25B 11/069; C25B 9/23; C25B 11/032; C25B 11/054

(52) U.S. Cl. CPC C25B 11/069; C25B 9/23; C25B 11/032; C25B 11/054

(57) ABSTRACT

A catalyst having a high production efficiency of a synthetic gas, including CO, a cathode, an ion exchange membrane-electrode assembly, and a solid electrolyte electrolysis apparatus. The catalyst includes fine particles selected from gold, silver, copper, nickel, iron, cobalt, zinc, chromium, palladium, tin, manganese, aluminum, indium, bismuth, molybdenum, and carbon nitride, a metal complex including a metal selected from copper, nickel, iron, cobalt, zinc, manganese, molybdenum, and aluminum, or an ion of the metal, having a ligand coordinated to the metal, and a carrier including carbon the carrier having a nitrogen-containing heteroaryl group having a primary amino group on a surface.

### TECHNICAL FIELD

The technique of the present disclosure relates to a catalyst, a cathode, an ion exchange membrane-electrode assembly, and a solid electrolyte electrolysis apparatus.

### BACKGROUND ART

Carbon dioxide is emitted when energy is extracted from a fossil fuel or the like. The increase of the concentration of carbon dioxide in the atmosphere is said to be one of the causes of the global warming. Carbon dioxide is an extremely stable substance, and therefore there has been substantially no way to use. However, in view of the demand of the times where the global warming becomes more serious, a new technology is needed to convert carbon dioxide into other substances and to recycle as a resource again. For example, a carbon dioxide reduction apparatus capable of directly reducing carbon dioxide in gaseous state is being developed.
For example, PTL 1 intends to enhance the production efficiency of a synthetic gas containing CO, and describes the use of an electrode including a catalyst generating at least carbon monoxide through reduction reaction, an electrode material having the catalyst, and a solid base provided at least on the electrode material.
PTL 2 intends to provide a carbon dioxide reducing membrane that is excellent in retention capability of carbon dioxide and is also excellent in protonic conductivity without the use of an electrolytic solution, and describes that a conductive material, a carbon dioxide adsorbent, and a proton permeable polymer are contained in a carbon dioxide reducing membrane.
PTL 3 describes, as a carbon dioxide reducing apparatus capable of improving both the reduction efficiency and the durability, a carbon dioxide reducing apparatus including a first electrode, at least one of an electrolytic solution and an ion transporting membrane, and a second electrode, in which the first electrode includes a reduction catalyst reducing carbon dioxide, and contains at least one of an amino acid having a particular structure and a polyamino acid having a particular structure in the same space as where carbon dioxide is reduced.

Furthermore, NPL 1 describes a carbon dioxide reducing apparatus including an electrode for reducing carbon dioxide that contains phenol as an additive for enhancing the retention capability of carbon dioxide in the same space as the reduction catalyst.

### CITATION LIST

### Patent Literatures

PTL 1: WO 2020/218371
PTL 2: JP 2019-11492 A
PTL 3: JP 2019-59999 A

### Non-Patent Literature

NPL 1: S. Ren, D. Joulie, D. Salvatore, K. Torbensen, M. Wang, M. Robert, C. P. Berlinguette, Science, 2019, 365, 367-369

### SUMMARY OF INVENTION

### Technical Problem

In PTL 1, basic metal oxide fine particles are co-supported, and in PTLs 2 and 3 and NPL 1, a nitrogen-containing organic compound is used by coordinating to or mixing with a metal catalyst.

However, the solid bases prepared by these methods exist through physical mixing with the catalyst carrier, and therefore have a problem of limitation in the effect of enhancing the productivity of the reduction product, due to the low adhesion to the catalyst.

The technique of the present disclosure is developed in view of the aforementioned circumstances, and a problem to be solved by the technique of the present disclosure is to provide a catalyst that has a high production efficiency of a synthetic gas containing CO, a cathode, an ion exchange membrane-electrode assembly, and a solid electrolyte electrolysis apparatus.

### Solution to Problem

<1>A catalyst including
fine particles selected from the group consisting of gold, silver, copper, nickel, iron, cobalt, zinc, chromium, palladium, tin, manganese, aluminum, indium, bismuth, molybdenum, and carbon nitride; or a metal complex containing a metal selected from the group consisting of copper, nickel, iron, cobalt, zinc, manganese, molybdenum, and aluminum, or an ion of the metal, having a ligand coordinated thereto, and
a carrier containing carbon,
the carrier having on a surface thereof a nitrogen-containing heteroaryl group having a primary amino group.
<2> The catalyst according to the item <1>, in which the nitrogen-containing heteroaryl group has a cyclic structure represented by the formula (1):

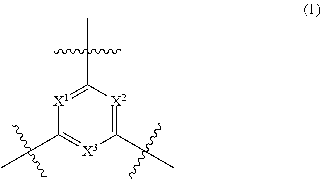

wherein, X¹ to X³ each independently represent a carbon atom or a nitrogen atom, in which at least one of X¹ to X³ represents a nitrogen atom, and in the case where X¹ to X³ represent carbon atoms, the carbon atom has a hydrogen atom or a primary amino group.
<3> The catalyst according to the item <1> or <2>, in which the nitrogen-containing heteroaryl group having a primary amino group is represented by the following formula (2):

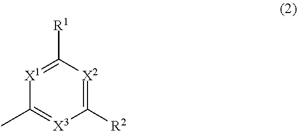

wherein, X¹ to X³ each independently represent a carbon atom or a nitrogen atom, in which at least one of X¹ to X³ represents a nitrogen atom, and in the case where X¹ to X³ represent carbon atoms, the carbon atom has a hydrogen atom or a primary amino group, and R¹ and R² each independently represent a primary amino group or a hydrocarbon group, and at least one primary amino group exists in the formula (2).
<4> The catalyst according to the item <1>, in which the nitrogen-containing heteroaryl group has a cyclic structure represented by the formula (4):

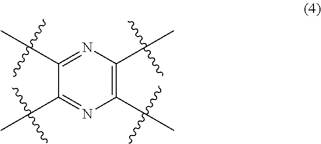 [SMILES: *c1nc(*)c(*)nc1*]

<5> The catalyst according to the item <1> or <4>, in which the nitrogen-containing heteroaryl group having a primary amino group is represented by the following formula (5):

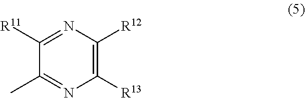

wherein, R¹¹ to R¹³ each independently represent a primary amino group, a hydrocarbon group, or a hydrogen atom, and at least one primary amino group exists in the formula (5).
<6> A cathode including a catalyst layer containing the catalyst according to any one of the items <1> to <5>, and a gas diffusion layer.
<7> An ion exchange membrane-electrode assembly including the cathode according to the item <6>, a solid electrolyte, and an anode.

The ion exchange membrane-electrode assembly according to the item <7>, in which the solid electrolyte is an anion exchange membrane.
<9> A solid electrolyte electrolysis apparatus including
the cathode according to the item <6>,
an anode constituting a pair of electrodes with the cathode,
a solid electrolyte intervening between the cathode and the anode, in a contact state, and
a voltage application unit applying a voltage between the cathode and the anode.
<10> The solid electrolyte electrolysis apparatus according to the item <9>, in which the solid electrolyte is an anion exchange membrane.

### Advantageous Effects of Invention

The technique of the present disclosure can provide a catalyst that has a high production efficiency of a synthetic gas containing CO, a cathode, an ion exchange membrane-electrode assembly, and a solid electrolyte electrolysis apparatus.

### BRIEF DESCRIPTION OF DRAWINGS

FIG. 1 is a schematic illustration showing an ion exchange membrane-electrode assembly that is favorably used in the present embodiment.

FIG. 2 is a schematic illustration showing a solid electrolyte electrolysis apparatus that is favorably used in the present embodiment.

FIG. 3 is the temperature-programmed desorption spectrum of carbon dioxide gas of the catalyst carrier of Example 1.

FIG. 4 is the temperature-programmed desorption spectrum of carbon dioxide gas of the catalyst carrier of Comparative Example 1.

### DESCRIPTION OF EMBODIMENTS

The upper limit values and the lower limit values of the numerical ranges described in the description herein can be optionally combined. For example, in the case where “A to B” and “C to D” are described as numerical ranges, numerical ranges “A to D” and “C to B” are also encompassed in the range of the present disclosure.

The numerical range “lower limit value to upper limit value” described in the description herein means the lower limit value or more and the upper limit value or less unless otherwise indicated.

### <Catalyst>

The catalyst according to an embodiment of the present disclosure includes
fine particles selected from the group consisting of gold, silver, copper, nickel, iron, cobalt, zinc, chromium, palladium, tin, manganese, aluminum, indium, bismuth, molybdenum, and carbon nitride; or a metal complex containing a metal selected from the group consisting of copper, nickel, iron, cobalt, zinc, manganese, molybdenum, and aluminum, or an ion of the metal, having a ligand coordinated thereto, and
a carrier containing carbon, and
the carrier has on a surface thereof a nitrogen-containing heteroaryl group having a primary amino group.

In the catalyst of the present disclosure, the component that exhibits the catalytic action of reduction reaction of carbon dioxide is the fine particles or the metal complex, and in the technique of the present disclosure, the fine particles or the metal complex is referred to as a “catalyst source”, and a structure including the catalyst source and the carrier is referred to as a “catalyst”.

In the CO₂ reduction, the CO₂ adsorption amount in the vicinity of the CO₂ reduction catalyst strongly contributes to the production efficiency of the reduction product, such as CO. The patent literatures and non-patent literatures described above devise a method in which a compound having a capability of performing an interaction, such as adsorption, on CO₂ is co-supported on the electrode along with the catalyst, and thereby the adsorption amount of CO₂, which is weakly acidic, is enhanced to improve the production efficiency, but the production efficiency of the reduction product is still low.

On the other hand, a cathode including the catalyst according to the present embodiment has a production efficiency of a synthetic gas containing CO that is higher than ever. The mechanism therefor is estimated as follows.

It is considered that in the ordinary techniques, the basic substance having a capability of performing an interaction, such as adsorption, on CO₂ is physically mixed with the catalyst, and remains existing in the electrode, and therefore the supply of carbon dioxide to the catalyst is unstable.

On the other hand, the catalyst according to the present embodiment has a carrier constituting the catalyst, having on the surface thereof a nitrogen-containing heteroaryl group having a primary amino group. In other words, a nitrogen-containing heteroaryl group having a primary amino group is fixed to the surface of the carrier through chemical bond. It is considered that carbon dioxide with weak acidity undergoes neutralization with a primary amino group having weak basicity, and thereby the local carbon dioxide concentration in the vicinity of the surface of the carrier is increased to enhance the reduction rate. It is estimated that according to the mechanism, carbon dioxide can be stably supplied to the catalyst source supported on the carrier, and thus a cathode including the catalyst according to the present embodiment can enhance the production efficiency of a synthetic gas containing CO.

The catalyst, the cathode, the ion exchange membrane-electrode assembly, and the electrolysis apparatus according to the present embodiment will be described below sequentially. First, the fine particles and the metal complex included in the catalyst according to the present embodiment will be described.

### [Fine Particles and Metal Complex]

The catalyst according to the present embodiment includes fine particles or a metal complex as a catalyst source.

The fine particles and the metal complex according to the present embodiment has a function of generating at least carbon monoxide through reduction reaction.

The fine particles and the metal complex are supported on a carrier by performing a known method, such as vapor deposition, deposition, adsorption, accumulation, adhesion, welding, physical mixing, and spraying.

### (Fine Particles)

The fine particles in the present embodiment are inorganic fine particles selected from the group consisting of gold, silver, copper, nickel, iron, cobalt, zinc, chromium, palladium, tin, manganese, aluminum, indium, bismuth, molybdenum, and carbon nitride, and one kind thereof may be used, or two or more kinds thereof may be used in combination.

Among the above, the material of the fine particle is preferably silver, gold, zinc, tin, copper, and bismuth, more preferably silver, gold, copper, and tin, and further preferably silver, gold, and copper, from the standpoint of the reaction efficiency of the carbon dioxide reduction reaction.

The average particle diameter of the fine particles as the catalyst source is preferably 65 nm or less, preferably 60 nm or less, preferably 50 nm or less, preferably 40 nm or less, and preferably 30 nm or less, from the standpoint of the reaction rate of the carbon dioxide reduction reaction. The lower limit value of the average particle diameter is not particularly limited, and is preferably 1 nm or more, and more preferably 5 nm or more, from the standpoint of the productivity.

The average particle diameter can be measured by observing a photograph of a scanning electron microscope, or the like.

### [Metal Complex]

The metal complex in the present embodiment is a metal complex containing a metal or an ion of the metal, having a ligand coordinated thereto, in which the metal is selected from the group consisting of copper, nickel, iron, cobalt, zinc, manganese, molybdenum, and aluminum.

Among the above, the metal is preferably nickel, cobalt, iron, copper, zinc, and manganese, more preferably nickel, cobalt, iron, and copper, and further preferably nickel, cobalt, and iron, from the standpoint of the reaction efficiency of the carbon dioxide reduction reaction. The metal complex may contain one kind of the metal and the ion of the metal, or may contain two or more kinds thereof.

The kind of the ligand is not particularly limited, and examples thereof include a phthalocyanine complex, a porphyrin complex, a pyridine complex, a metal-modified covalent triazine framework, and a metal organic framework. Among these, a phthalocyanine complex, a porphyrin complex, a pyridine complex, and a metal-modified covalent triazine framework are preferred, a phthalocyanine complex, a porphyrin complex, and a metal-modified covalent triazine framework are more preferred, and a porphyrin complex and a metal-modified covalent triazine framework are further preferred. The metal complex may contain one kind of the ligand, or may contain two or more kinds thereof.

### [Carrier]

The carrier according to the present embodiment contains carbon, and has on the surface thereof a nitrogen-containing heteroaryl group having a primary amino group. Carbon generally has conductivity, and therefore the carrier according to the present embodiment is a conductive carrier.

The nitrogen-containing heteroaryl group having a primary amino group is fixed to the surface of the carrier through chemical bond, and thereby carbon dioxide can be stably supplied to the catalyst source.

### (Carbon)

The carbon is not limited, as long as being a conductive carbon material that can be used as a gas diffusion layer in an electrode provided in an apparatus for reducing carbon dioxide, and examples thereof include carbon black (such as furnace black, acetylene black, Ketjen black, and medium thermal carbon black), activated carbon, graphite, carbon nanotubes, carbon nanofibers, carbon nanohorns, graphene nanoplatelets, and nanoporous carbon, in which carbon black is preferred. In addition, the structure thereof is preferably a porous structure. Examples of the carbon having a porous structure include a porous carbon material represented by graphene.

The shape, size, grade, and the like of the carbon black are not limited, and the DBP oil adsorption amount (dibutyl phthalate oil adsorption amount) is preferably 50 to 500 mL/100 g, more preferably 100 to 300 mL/100 g, and further preferably 100 to 200 mL/100 g. The primary particle diameter is preferably 5 to 200 nm, more preferably 10 to 100 nm, and further preferably 10 to 50 nm.

The DBP oil adsorption amount of the carbon black can be obtained by JIS K 6217-4:2001 (determination of oil adsorption amount), and the primary particle diameter can be obtained, for example, by the laser diffraction particle size distribution measurement.

The carbon black may be a commercially available product, and examples thereof include Vulcan (registered trade name) XC-72 (available from Cabot Corporation), Denka Black HS-100 (available from Denka Co., Ltd.), Ketjen Black EC-600JD (available from Lion Specialty Chemicals Co., Ltd.), and Conductex-7055 Ultra (available from Birla Carbon Corporation).

### (Nitrogen-Containing Heteroaryl Group Having Primary Amino Group)

The carrier according to the present embodiment has on the surface thereof a nitrogen-containing heteroaryl group having a primary amino group.

The nitrogen-containing heteroaryl group is not particularly limited. The nitrogen-containing heteroaryl group is expressed by a group that is obtained by removing one hydrogen atom from a nitrogen-containing heterocyclic ring, and the nitrogen-containing heterocyclic ring may be a monocyclic ring or a condensed ring.

Specific examples of the nitrogen-containing heteroaryl group include groups obtained by removing one hydrogen atom from nitrogen-containing heterocyclic rings, such as pyridine, pyrazine, pyrimidine, pyridazine, triazine, quinoline, isoquinoline, pyrrole, imidazole, pyrazole, indole, carbazole, phenanthridine, acridine, naphthyridine, benzimidazole, indazole, quinoxaline, quinazoline, purine, and pteridine.

Among the above, the nitrogen-containing heteroaryl group preferably has a cyclic structure represented by the formula (1) or (4).

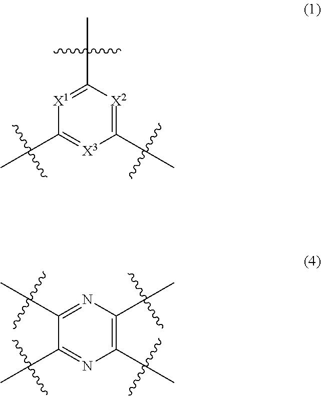

In the formula (1), X¹ to X³ each independently represent a carbon atom or a nitrogen atom, in which at least one of X¹ to X³ represents a nitrogen atom, and in the case where X¹ to X³ represent carbon atoms, the carbon atom has a hydrogen atom or a primary amino group. In the formula (1), for example, X¹ to X³ each can independently represent C—H or C—NH₂.

Examples of the nitrogen-containing heteroaryl group having a cyclic structure represented by the formula (1) include groups obtained by removing one hydrogen atom from nitrogen-containing heterocyclic rings, such as pyridine, pyrimidine, triazine, quinoline, isoquinoline, phenanthridine, acridine, naphthyridine, and quinazoline.

The nitrogen-containing heteroaryl group having a cyclic structure represented by the formula (4) is a group obtained by removing one hydrogen atom from pyrazine.

From the standpoint of enhancing the amount of carbon dioxide supplied to the catalyst, it is preferred that in the formula (1), any two of X¹ to X³ are nitrogen atoms, and it is more preferred that all three thereof are nitrogen atoms.

Specifically, the nitrogen-containing heteroaryl group is preferably a group obtained by removing one hydrogen atom from any one of a nitrogen-containing heterocyclic ring selected from the group consisting of pyrimidine, pyradine, triazine, naphthyridine, and quinazoline, more preferably a group obtained by removing one hydrogen atom from any one of a nitrogen-containing heterocyclic ring selected from the group consisting of pyrimidine, triazine, naphthyridine, and quinazoline, and further preferably a group obtained by removing one hydrogen atom from triazine, i.e., a triazinyl group.

The nitrogen-containing heteroaryl group has at least one primary amino group. The number of the primary amino group is not particularly limited, as long as being 1 or more. For example, in the case where the nitrogen-containing heteroaryl group is pyrimidyl group, the pyrimidyl group may have 1 to 4 primary amino groups, and in the case where the nitrogen-containing heteroaryl group is a quinolinyl group, the quinolinyl group may have 1 to 6 primary amino groups.

The nitrogen-containing heteroaryl group may further have a substituent in addition to the primary amino group. Examples of the substituent include an alkyl group and an aryl group.

Among the above, the nitrogen-containing heteroaryl group having a primary amino group is preferably represented by the formula (2) or (5) from the standpoint of further enhancing the amount of carbon dioxide supplied to the catalyst.

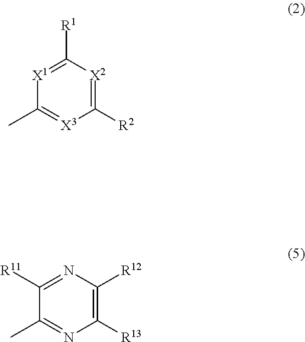

In the formula (2), X¹ to X³ each independently represent a carbon atom or a nitrogen atom, in which at least one of X¹ to X³ represents a nitrogen atom, and in the case where X¹ to X³ represent carbon atoms, the carbon atom has a hydrogen atom or a primary amino group, and R¹ and R² each independently represent a primary amino group or a hydrocarbon group, and at least one primary amino group exists in the formula (2).

In the formula (5), R¹¹ to R¹³ each independently represent a primary amino group, a hydrocarbon group, or a hydrogen atom, and at least one primary amino group exists in the formula (5).

Examples of the hydrocarbon group include an alkyl group and an aryl group.

The alkyl group may be linear, branched, or cyclic, and preferably has 1 to 10 carbon atoms. In particular, a linear alkyl group having 1 to 5 carbon atoms is more preferred, and a methyl group is further preferred.

Examples of the aryl group include a phenyl group and a naphthyl group, and preferably has 5 to 10 carbon atoms. In particular, an aryl group having 6 to 8 carbon atoms is more preferred, and a phenyl group is further preferred.

In each of the formula (2) and the formula (5) independently, at least one primary amino group exists.

In the formula (2), one of X¹ to X³ represents a carbon atom to form a structure having a primary amino group (C—NH₂), or R¹ or R² may represent a primary amino group.

In the nitrogen-containing heteroaryl group having a primary amino group represented by the formula (2), it is preferred that any two of X¹ to X³ in the formula (2) represent nitrogen atoms, and it is more preferred that all three thereof represent nitrogen atoms, from the standpoint of further enhancing the amount of carbon dioxide supplied to the catalyst. From the same standpoint, it is preferred that both R¹ and R² in the formula (2) represent primary amino groups.

In the formula (5), one of R¹¹ to R¹³ may represent a primary amino group, or all thereof may represent primary amino groups. It is possible that one or more of R¹¹ to R¹³ represents a hydrocarbon group, and a primary amino group exists as a substituent of the hydrocarbon group. Both of the structures may exist in combination.

In the nitrogen-containing heteroaryl group having a primary amino group represented by the formula (5), it is preferred that at least R¹¹ in the formula (5) represents a primary amino group from the standpoint of further enhancing the amount of carbon dioxide supplied to the catalyst.

In a specific preferred embodiment of the nitrogen-containing heteroaryl group having a primary amino group represented by the formula (2), two or three of X¹ to X³ represent nitrogen atoms, and R¹ and R² each independently represent a linear alkyl group having 1 to 5 carbon atoms, an aryl group having 6 to 8 carbon atoms, or a primary amino group, and at least one of R¹ and R² represents a primary amino group, and in the case where any two of X¹ to X³ represent nitrogen atoms, the rest one thereof represents a carbon atom having one hydrogen atom bonded thereto (C—H).

In a specific more preferred embodiment of the nitrogen-containing heteroaryl group having a primary amino group represented by the formula (2), two or three of X¹ to X³ represent nitrogen atoms, and R¹ and R² each independently represent an aryl group having 6 to 8 carbon atoms or a primary amino group, and at least one of R¹ and R² represents a primary amino group, and in the case where any two of X¹ to X³ represent nitrogen atoms, the rest one thereof represents a carbon atom having one hydrogen atom bonded thereto (C—H).

In the case where three of X¹ to X³ represent nitrogen atoms in the nitrogen-containing heteroaryl group having a primary amino group represented by the formula (2), it is possible to use an embodiment in which R¹ and R² each independently represent a linear alkyl group having 1 to 5 carbon atoms, an aryl group having 6 to 8 carbon atoms, or a primary amino group, and at least one of R¹ and R² represents a primary amino group.

In a specific further preferred embodiment of the nitrogen-containing heteroaryl group having a primary amino group represented by the formula (2), three of X¹ to X³ represent nitrogen atoms, and R¹ and R² each independently represent an aryl group having 6 to 8 carbon atoms or a primary amino group, and at least one of R¹ and R² represents a primary amino group.

In a specific still further preferred embodiment of the nitrogen-containing heteroaryl group having a primary amino group represented by the formula (2), three of X¹ to X³ represent nitrogen atoms, and R¹ and R² represent primary amino groups.

In a specific preferred embodiment of the nitrogen-containing heteroaryl group having a primary amino group represented by the formula (5), R¹¹ represents a primary amino group, and R¹² and R¹³ represent hydrogen atoms.

Among the above, the nitrogen-containing heteroaryl group having a primary amino group is preferably represented by the formula (2).

One kind of the nitrogen-containing heteroaryl group having a primary amino group that the carrier according to the present embodiment has may be used, or two or more kinds thereof may be used.

Furthermore, the carrier according to the present embodiment may have one nitrogen-containing heteroaryl group having a primary amino group, or may have two thereof. The amount of the nitrogen-containing heteroaryl group having a primary amino group that the carrier according to the present embodiment has can be quantitatively determined by neutralization reaction.

### [Method for Introducing Nitrogen-Containing Heteroaryl Group Having Primary Amino Group]

The method for introducing the nitrogen-containing heteroaryl group having a primary amino group to the surface of the carrier according to the present embodiment is not particularly limited.

For example, it is possible that carbon black is used as the carrier according to the present embodiment, and nucleophilic reaction is allowed to occur on the aromatic ring or the like on the surface of the carbon black through diazo reaction with a nitrogen-containing heterocyclic compound having two or more primary amino groups as a precursor, so as to form a chemical bond therebetween.

Examples of the nitrogen-containing heterocyclic compound having two or more primary amino groups include a compound including a nitrogen-containing heterocyclic ring having two or more primary amino groups, such as pyridine, pyrazine, pyrimidine, pyridazine, triazine, quinoline, isoquinoline, pyrrole, imidazole, pyrazole, indole, carbazole, phenanthridine, acridine, naphthyridine, benzimidazole, indazole, quinoxaline, quinazoline, purine, and pteridine.

The nitrogen-containing heterocyclic compound having two or more primary amino groups may further have a substituent in addition to the primary amino groups. Examples of the substituent include an alkyl group and an aryl group.

The nitrogen-containing heterocyclic compound having two or more primary amino groups is preferably represented by the following formula (3) or (6).

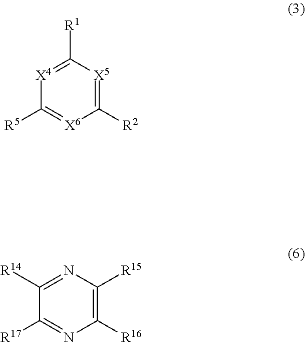

In the formula (3), X⁴ to X⁶ each independently represent a carbon atom or a nitrogen atom, in which at least one of X⁴ to X⁶ represents a nitrogen atom, and in the case where X¹ to X³ represent carbon atoms, the carbon atom has a hydrogen atom or a primary amino group, and R³ to R⁵ each independently represent a primary amino group or a hydrocarbon group, and at least two primary amino groups exist in the formula (3).

In the formula (6), R¹⁴ to R¹⁷ each independently represent a primary amino group, a hydrocarbon group, or a hydrogen atom, and at least two primary amino groups exist in the formula (5).

Examples of the hydrocarbon group include an alkyl group and an aryl group.

The alkyl group may be either linear, branched, or cyclic, and preferably has 1 to 10 carbon atoms. In particular, a linear alkyl group having 1 to 5 carbon atoms is more preferred, and a methyl group is further preferred.

Examples of the aryl group include a phenyl group and a naphthyl group, and preferably has 5 to 10 carbon atoms. In particular, an aryl group having 6 to 8 carbon atoms is more preferred, and a phenyl group is further preferred.

In each of the formula (3) and the formula (6) independently, at least two primary amino groups exist.

In the formula (3), two or more of X¹ to X³ may represent carbon atoms to form a structure having a primary amino group (C—NH₂), or two or more of R³ to R⁵ may represent primary amino groups, or both of the structures may exist in combination.

In the nitrogen-containing heterocyclic compound having two or more primary amino groups represented by the formula (3), it is preferred that any two of X⁴ to X⁶ in the formula (3) represent nitrogen atoms, and it is more preferred that all three thereof represent nitrogen atoms, from the standpoint of further enhancing the amount of carbon dioxide supplied to the catalyst. From the same standpoint, it is preferred that all R³ to R⁵ in the formula (3) represent primary amino groups.

In the formula (6), two or more of R¹⁴ to R¹⁷ may represent primary amino groups. It is possible that one or more of R¹⁴ to R¹⁷ represents a hydrocarbon group, and a primary amino group exists as a substituent of the hydrocarbon group. In addition, both of the structures may exist in combination.

In the nitrogen-containing heterocyclic compound having two or more primary amino groups represented by the formula (6), it is preferred that R¹⁶ or R¹⁷ in the formula (6) represents a primary amino group from the standpoint of further enhancing the amount of carbon dioxide supplied to the catalyst.

In a specific preferred embodiment of the nitrogen-containing heterocyclic compound having two or more primary amino groups represented by the formula (3), two or three of X⁴ to X⁶ represent nitrogen atoms, and R³ to R⁵ each independently represent a linear alkyl group having 1 to 5 carbon atoms, an aryl group having 6 to 8 carbon atoms, or a primary amino group, and at least two of R³ to R⁵ represent primary amino groups.

In a specific more preferred embodiment of the nitrogen-containing heterocyclic compound having two or more primary amino groups represented by the formula (3), two or three of X⁴ to X⁶ represent nitrogen atoms, and R³ to R⁵ each independently represent an aryl group having 6 to 8 carbon atoms or a primary amino group, and at least two of R³ to R⁵ represent primary amino groups.

In the case where three of X⁴ to X⁶ represent nitrogen atoms in the nitrogen-containing heterocyclic compound having two primary amino groups represented by the formula (3), it is possible to use an embodiment in which R³ to R⁵ each independently represent a linear alkyl group having 1 to 5 carbon atoms, an aryl group having 6 to 8 carbon atoms, or a primary amino group, and at least two of R³ to R⁵ represent primary amino groups.

In a specific further preferred embodiment of the nitrogen-containing heterocyclic compound having two or more primary amino groups represented by the formula (3), three of X⁴ to X⁶ represent nitrogen atoms, and R³ to R⁵ each independently represent an aryl group having 6 to 8 carbon atoms or a primary amino group, and at least two of R³ to R⁵ represent primary amino groups.

In a specific still further preferred embodiment of the nitrogen-containing heterocyclic compound having two or more primary amino groups represented by the formula (3), three of X⁴ to X⁶ represent nitrogen atoms, and R³ to R⁵ represent primary amino groups.

In a specific preferred embodiment of the nitrogen-containing heterocyclic compound having two or more primary amino groups represented by the formula (6), R¹⁴ and R¹⁷ represent primary amino groups, or R¹⁵ and R¹⁷ represent primary amino groups.

Among the above, the nitrogen-containing heterocyclic compound having two or more primary amino groups is preferably represented by the formula (3).

Additionally, the catalyst with the technique of the present disclosure is preferably coated with an ionomer, which is described later. The ionomer coated on the catalyst facilitates the formation of the ionic conductive channel of the coated catalyst and the solid electrolyte described later, and facilitates the migration of ions formed through the reaction, and thereby the electrolysis efficiency can be enhanced.

### [Method for Producing Catalyst]

The method for producing the catalyst according to the present embodiment is not particularly limited.

For example, it is possible that the nitrogen-containing heteroaryl group having a primary amino group is introduced to the surface of the carrier according to the present embodiment by the method for introducing the nitrogen-containing heteroaryl group having a primary amino group described above, and then the catalyst source is supported on the carrier. It is also possible that in the opposite manner, the catalyst source is supported on the carrier, and then the nitrogen-containing heteroaryl group having a primary amino group is introduced to the surface of the carrier.

It is preferred that the nitrogen-containing heteroaryl group having a primary amino group is introduced, and then the catalyst source is supported on the carrier, from the standpoint of securing the cleanliness of the surface of the catalyst, i.e., the standpoint of preventing the surface of the catalyst from being covered with the aryl group.

### <Cathode>

The cathode according to the present embodiment includes a catalyst layer containing the catalyst according to the present embodiment described above, and a gas diffusion layer.

The present embodiment has a high production efficiency of a synthetic gas containing CO due to the catalyst layer containing the catalyst according to the present embodiment.

### [Catalyst Layer]

The catalyst layer contains at least the catalyst according to the present embodiment, and may further contain an ionomer.

The ionomer functions as a binder resin in the catalyst layer to be a matrix resin (continuous phase) capable of dispersing and fixing the catalyst according to the present embodiment, and also has a function of conducting ions formed through electrolysis and enhancing the electrolysis efficiency of CO₂. The ionomer is preferably conductive, and is more preferably a polymer electrolyte, from the standpoint of enhancing the conductive efficiency of ions formed through electrolysis. The polymer electrolyte is further preferably an ion exchange resin. The ion exchange resin may be either a cation exchange resin or an anion exchange resin, and is preferably an anion exchange resin.

With the use of an anion exchange resin, in particular, the anion exchange resin itself has a function of adsorbing carbon dioxide, which can largely enhance the electrolysis efficiency of carbon dioxide, in cooperation with the high ion conduction of the ion exchange resin.

Examples of the cation exchange resin include a fluorine resin having a sulfone group and a styrene-divinylbenzene copolymer having a sulfone group. A commercially available product may also be used therefor, and examples thereof include Nafion (available from Chemours Company), Aquivion (available from Solvay Specialty Polymers, Inc.), Diaion (available from Mitsubishi Chemical Corporation), and Fumasep (available from Fumatech BWT GmbH).

Examples of the anion exchange resin include a resin having one or more of an ion exchange group selected from the group consisting of a quaternary ammonium group, a primary amino group, a secondary amino group, and a tertiary amino group. A commercially available product may also be used therefor, and examples thereof include Sustainion (available from Dioxide Materials, Inc.), Fumasep (available from Fumatech BWT GmbH), Pention (available from Xergy, Inc.), Durion (available from Xergy, Inc.), Neosepta (available from Astom Corporation), and Toyopearl (available from Tosoh Corporation).

The anion exchange resin preferably has a base site density in a dry state of 2.0 to 5.0 mmol/cm³, more preferably 2.5 mmol/cm³ or more and less than 4.5 mmol/cm³, and further preferably 2.9 mmol/cm³ or more and less than 4.5 mmol/cm³, from the standpoint of enhancing the conductivity.

The base site density of the anion exchange resin can be obtained from the integral value of the signal in ¹H-NMR measurement of the anion exchange resin.

The dry state of the anion exchange resin means that the content of free water in the anion exchange resin is 0.01 g or less per 1 g of resin, and for example, the dry state can be obtained by heating the anion exchange resin in vacuum.

In the case where the cathode according to the present embodiment is used in the ion exchange membrane-electrode assembly described later or the solid electrolyte electrolysis apparatus described later, the ionomer to be used is preferably the same resin as the solid electrolyte (ion exchange membrane) from the standpoint of enhancing the conductivity.

The content of the catalyst according to the present embodiment in the catalyst layer is preferably 5 to 90% by mass, more preferably 10 to 80% by mass, and further preferably 15 to 60% by mass, from the standpoint of further enhancing the production efficiency of a synthetic gas containing CO.

### [Gas Diffusion Layer]

The gas diffusion layer contains, for example, carbon paper or nonwoven fabric, or a metal mesh. Examples thereof include graphite carbon, glassy carbon, titanium, and a stainless steel.

### [Ion Exchange Membrane-Electrode Assembly]

The ion exchange membrane-electrode assembly according to the present embodiment includes the cathode according to the present embodiment described above, a solid electrolyte, and an anode.

The ion exchange membrane-electrode assembly according to the present embodiment includes the cathode that includes the catalyst according to the present embodiment, and thereby has a high production efficiency of a synthetic gas containing CO.

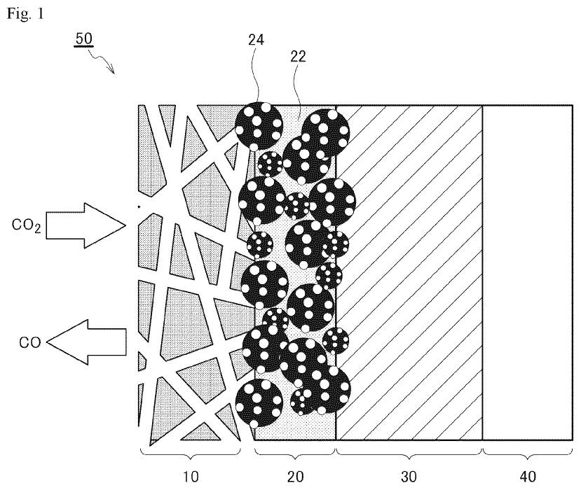

FIG. 1 is a schematic illustration showing an ion exchange membrane-electrode assembly that is favorably used in the present embodiment. FIG. 1 shows an ion exchange membrane-electrode assembly 50 including a gas diffusion layer 10, a catalyst layer 20, a solid electrolyte layer 30, and an anode 40. The catalyst layer 20 contains the multiple catalysts 24 according to the present embodiment, and an ionomer 22. The combination of the gas diffusion layer 10 and the catalyst layer 20 constitutes the cathode according to the present embodiment.

As shown in FIG. 1, carbon dioxide (CO₂) is supplied to the catalyst layer 20 via the gas diffusion layer 10, and carbon monoxide (CO) is formed through reduction reaction.

The following description will be made with reference to FIG. 1 while omitting the symbols.

### [Solid Electrolyte]

The ion exchange membrane-electrode assembly according to the present embodiment includes a solid electrolyte.

The solid electrolyte used may be a polymer membrane. The polymer used may be various ionomers, and may be a cation exchange resin or an anion exchange resin, and an anion exchange resin is preferred. Accordingly, the solid electrolyte is preferably an anion exchange membrane. The same anion exchange resin as the ionomer used in the catalyst layer described above is more preferably used.

The solid electrolyte used may be a product that is commercially available as a cation exchange membrane or an anion exchange membrane.

In the case where an anion exchange membrane is used as the solid electrolyte, the base site density thereof in a dry state is preferably 0.5 to 5.0 mmol/cm³, more preferably 2.5 mmol/cm³ or more and less than 4.5 mmol/cm³, and further preferably 2.9 mmol/cm³ or more and less than 4.5 mmol/cm³.

Examples of the cation exchange membrane include a strongly acidic cation exchange membrane formed of a fluorine resin as a matrix having a sulfone group introduced thereto, Nafion 117, Nafion 115, Nafion 212, and Nafion 350 (available from Chemours Company), a strongly acidic cation exchange membrane formed of a styrene-divinylbenzene copolymer as a matrix having a sulfone group introduced thereto, and Neosepta CSE (available from Astom Corporation).

Examples of the anion exchange membrane include an anion exchange membrane having one or more ion exchange group selected from the group consisting of a quaternary ammonium group, a primary amino group, a secondary amino group, and a tertiary amino group. Specific examples thereof include Neosepta (registered trade name) ASE, AHA, ACS, and AFX (available from Astom Corporation), and Selemion (registered trade name) AMVN, DSVN, AAV, ASVN, and AHO (available from AGC Engineering Co., Ltd.).

As for reduction reaction of carbon dioxide, the reduction reaction in the cathode according to the present embodiment varies depending on the kind of the solid electrolyte. In the case where a cation exchange membrane is used as the solid electrolyte, the reduction reaction of the reaction formula (1) and the reaction formula (2) below occurs, and in the case where an anion exchange membrane is used as the solid electrolyte, the reduction reaction of the reaction formula (3) and the reaction formula (4) below occurs.

CO₂+2H⁻+2e⁻=>CO+H₂O (1)

2H⁺+2e⁻=>H₂ (2)

H₂O+CO₂+2e⁻=>CO+2OH⁻ (3)

2H₂O+2e⁻=>H₂+2OH⁻ (4)

### [Anode]

The oxidation reaction in an anode varies depending on the kind of the solid electrolyte. In the case where a cation exchange membrane is used as the solid electrolyte, the oxidation reaction of the reaction formula (5) occurs, and in the case where an anion exchange membrane is used as the solid electrolyte, the oxidation reaction of the reaction formula (6) occurs.

2H₂O=>O₂+4H⁺+4e⁻ (5)

4OH⁻=>O₂+2H₂O+4e⁻ (6)

The anode is a gas diffusion electrode including the gas diffusion layer.

The gas diffusion layer includes, for example, a metal mesh. Examples of the electrode material of the anode include Ir, IrO₂, Ru, RuO₂, Co, CoOx, Cu, CuOx, Fe, FeOx, FeOOH, FeMn, Ni, NiOx, NiOOH, NiCo, NiCe, NiC, NiFe, NiCeCoCe, NiLa, NiMoFe, NiSn, NiZn, SUS, Au, and Pt.

### <Solid Electrolyte Electrolysis Apparatus>

The solid electrolyte electrolysis apparatus according to the present embodiment includes the cathode according to the present embodiment described above, an anode constituting a pair of electrodes with the cathode, a solid electrolyte intervening between the cathode and the anode, in a contact state, and a voltage application unit applying a voltage between the cathode and the anode.

The solid electrolyte electrolysis apparatus according to the present embodiment includes the cathode that includes the catalyst according to the present embodiment, and thereby has a high production efficiency of a synthetic gas containing CO.

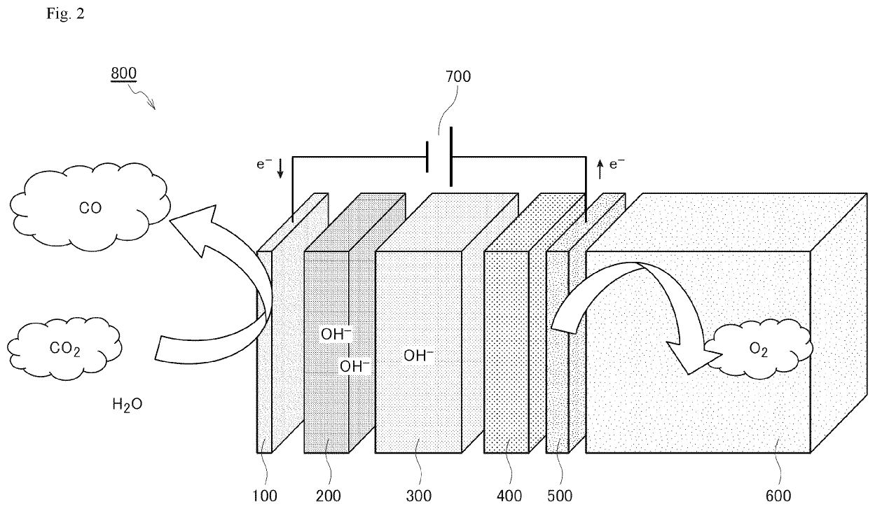

FIG. 2 is a schematic illustration showing a solid electrolyte electrolysis apparatus that is favorably used in the present embodiment.

FIG. 2 shows a solid electrolyte electrolysis apparatus 800 including the cathode 200 according to the present embodiment, an anode 400 constituting a pair of electrodes with the cathode 200, a solid electrolyte 300 intervening between the cathode 200 and the anode 400, in a contact state, and a voltage application unit 700 applying a voltage between the cathode 200 and the anode 400.

The solid electrolyte electrolysis apparatus 800 shown in FIG. 2 further includes a cathode collector 100, an anode collector 500, and an electrolytic solution 600.

The cathode according to the present embodiment is used as the cathode 200. The solid electrolyte 300 is the same as the solid electrolyte 30 in FIG. 1, and the solid electrolyte 300 is preferably an anion exchange membrane. The anode 400 is the same as the anode 40 in FIG. 1.

The details of the cathode 200, the solid electrolyte 300, and the anode 400 have been described above.

The components other than the cathode 200, the solid electrolyte 300, and the anode 400 will be described below while omitting the symbols.

### [Cathode Collector]

Examples of the cathode collector include a metal material, such as copper (Cu), nickel (Ni), a stainless steel (SUS), a nickel-plated steel, and brass, and among these, copper is preferred from the standpoint of the workability and the cost. Examples of the shape of the cathode collector in the case where the material is a metal material include a metal foil, a metal sheet, a thin metal film, an expanded metal, a punching metal, and a metal foam.

The cathode collector may have provided therein a gas supply hole for supplying the raw material gas containing carbon dioxide to the cathode, and a gas recovery hole for recovering the formed gas containing carbon monoxide. The gas supply hole and the gas recovery hole provided enable the uniform and efficient supply of the raw material gas to the cathode and recovery of the formed gas (including the unreacted raw material gas). Only one or two or more gas supply holes and only one or two or more gas recovery holes may be provided, independently. Furthermore, the shapes, the positions, the sizes, and the like of the gas supply holes and the gas recovery holes are not particularly limited and can be determined appropriately. In the case where the cathode collector has gas permeability, the gas supply holes and the gas recovery holes may not be necessarily provided.

In the case where the cathode has a function of conducting electrons, the cathode collector may not be necessarily provided.

### [Anode Collector]

The anode collector has electroconductivity for receiving electrons from the anode, and preferably has rigidity supporting the anode. From this standpoint, the anode collector used is preferably a metal material, such as titanium (Ti), copper (Cu), nickel (Ni), a stainless steel (SUS), a nickel-plated steel, and brass.

The anode collector may have provided therein a gas flow channel for delivering the raw material gas (such as H₂O) to the anode. The gas flow channel provided in the anode collector enables the unform and efficient delivery of the raw material gas to the anode. The number, the shape, the position, the size, and the like of the gas flow channel are not particularly limited and can be determined appropriately.

### [Voltage Application Unit]

The voltage application unit has a function of applying a voltage between the cathode and the anode through application of a voltage between the cathode collector and the anode collector. Both collectors are conductors, and therefore electrons are supplied to the cathode, whereas electrons are received from the anode. In addition, the voltage application unit may have a control unit, which is not shown in the figure, electrically connected thereto for applying an appropriate voltage.

### [Electrolytic Solution]

The electrolytic solution is preferably an aqueous solution having pH of 5 or more.

Examples thereof include a carbonate salt aqueous solution, a hydrogen carbonate salt aqueous solution (such as a KHCO₃ aqueous solution), a sulfate salt aqueous solution, a borate salt aqueous solution, sodium hydroxide, a potassium hydroxide aqueous solution, and a sodium chloride aqueous solution.

### (Reaction Gas Supply Unit)

The solid electrolyte electrolysis apparatus according to the present embodiment may have a reaction gas supply unit, which is not shown in the figure, outside the solid electrolyte electrolysis apparatus. Specifically, it suffices that CO₂ as the reaction gas is supplied to the catalyst layer of the cathode, in which the reaction gas may be supplied from the reaction gas supply unit to the gas supply hole via a pipe, which is not shown in the figure, or the reaction gas may be sprayed on the surface of the cathode collector opposite to the surface thereof in contact with the cathode. The reaction gas used is preferably a factory emission gas emitted from factories, from the environmental standpoint.

### [CO Generating Method]

A CO generating method using the solid electrolyte electrolysis apparatus according to the present embodiment will be then described.

CO₂ in a gas state, which is a reaction gas as a raw material, is supplied to the solid electrolyte electrolysis apparatus with the reaction gas supply unit, which is not shown in the figure. At this time, CO₂ is supplied to the cathode, for example, through the gas supply hole provided in the cathode collector.

Subsequently, CO₂ supplied to the cathode is brought into contact with the catalyst layer of the cathode, and thereby the reduction reaction of the reaction formula (1) and the reaction formula (2) described above occurs in the case where a cation exchange membrane is used as the solid electrolyte, or the reduction reaction of the reaction formula (3) and the reaction formula (4) described above occurs in the case where an anion exchange membrane is used as the solid electrolyte, resulting in a synthetic gas containing at least CO and H₂ formed.

Subsequently, for example, the synthetic gas containing at least CO and H₂ thus formed is supplied to a gas recovery unit, which is not shown in the figure, through the gas recovery hole provided in the cathode collector, and the prescribed gas species are recovered.

### EXAMPLES

The technique of the present disclosure will be then described with reference to examples, but the technique of the present disclosure is not limited to the examples.

### <Production of Catalyst Carrier>

### Example 1

An ethanol dispersion liquid containing 0.5 g of carbon black having a primary particle diameter of 30 nm was irradiated with ultrasonic wave for 10 minutes, and then the dispersion liquid was allowed to stand in a vacuum chamber in a reduced pressure state of 10 kPa (absolute pressure) for 10 minutes. Subsequently, 8.3 mL of a 0.5 mol/L sodium nitrite aqueous solution was added to the dispersion liquid. 4 mmol of melamine was added to the dispersion liquid, and then 2 mL of hydrochloric acid was added thereto, followed by agitating at 15° C. for 5 hours or more. After neutralizing the dispersion liquid by adding a sodium hydroxide solution, the resulting slurry was rinsed with distilled water, and the solid matter was recovered with a centrifugal separator, and then vacuum-dried at 60° C. overnight, resulting in a catalyst carrier of Example 1.

The primary particle diameter of the carbon black was obtained through laser diffraction particle size distribution measurement.

Melamine is a nitrogen-containing heterocyclic compound represented by the formula (3), in which three of X⁴ to X⁶ represent nitrogen atoms, and R³ to R⁵ represent primary amino groups.

### Example 2

A catalyst carrier of Example 2 was produced in the same manner as in the production of the catalyst carrier of Example 1 except that benzoguanamine was used instead of melamine.

Benzoguanamine is a nitrogen-containing heterocyclic compound represented by the formula (3), in which three of X⁴ to X⁶ represent nitrogen atoms, R³ represents a phenyl group, and R⁴ and R⁵ represent primary amino groups.

### Example 3

A catalyst carrier of Example 3 was produced in the same manner as in the production of the catalyst carrier of Example 1 except that 2,4-diamino-6-methyl-1,3,5-triazine was used instead of melamine.

2,4-Diamino-6-methyl-1,3,5-triazine is a nitrogen-containing heterocyclic compound represented by the formula (3), in which three of X⁴ to X⁶ represent nitrogen atoms, R³ represents a methyl group, and R⁴ and R⁵ represent primary amino groups.

### Example 4

A catalyst carrier of Example 4 was produced in the same manner as in the production of the catalyst carrier of Example 1 except that 2,4-diaminopyridine was used instead of melamine.

2,4-Diaminopyridine is a nitrogen-containing heterocyclic compound represented by the formula (3), in which two of X⁴ and X⁵ represent nitrogen atoms, X⁶ represents a carbon atom having a hydrogen atom (C—H), R³ and R⁴ represent primary amino groups.

### Example 5

A catalyst carrier of Example 5 was produced in the same manner as in the production of the catalyst carrier of Example 1 except that 3,4-diaminopyridine was used instead of melamine.

3,4-Diaminopyridine is a nitrogen-containing heterocyclic compound represented by the formula (3), in which X⁴ represents a nitrogen atom, X⁵ represents a carbon atom having a hydrogen atom (C—H), X⁶ represents a carbon atom having a primary amino group (C—NH₂), and R⁴ represents a primary amino group.

### Example 6

A catalyst carrier of Example 6 was produced in the same manner as in the production of the catalyst carrier of Example 1 except that 2,3-diaminopyrazine was used instead of melamine.

2,3-Diaminopyrazine is a nitrogen-containing heterocyclic compound represented by the formula (6), in which R¹⁴ and R¹⁷ represent primary amino groups, and R¹⁵ and R¹⁶ represent hydrogen atoms.

### Comparative Example 1

Carbon black having a primary particle diameter of 30 nm was used as a catalyst carrier of Comparative Example 1.

### Comparative Example 2

A catalyst carrier of Comparative Example 2 was produced in the same manner as in the production of the catalyst carrier of Example 1 except that 4-aminobenzylamine was used instead of melamine.

4-Aminobenzylamine has two primary amino groups, but is not a nitrogen-containing heterocyclic compound.

### Comparative Example 3

A catalyst carrier of Comparative Example 2 was produced in the same manner as in the production of the catalyst carrier of Example 1 except that 4,4′-diaminodiphenylmethane was used instead of melamine.

4,4′-Diaminodiphenylmethane has two primary amino groups, but is not a nitrogen-containing heterocyclic compound.

### <Evaluation of Temperature-Programmed Desorption of Carbon Dioxide Gas>

0.1 g of each of the catalyst carriers of Example 1 and Comparative Example 1 was charged in a glass reaction tube, and heated to 250° C. for 4 to 5 minutes under a nitrogen stream to remove gas adsorbed on the surface of the catalyst carrier. Thereafter, the catalyst carrier was exposed to an environment of 40° C. under a carbon dioxide stream for 60 minutes. Subsequently, the catalyst carrier was heated at a temperature rise rate of 10° C./min under a helium stream, and the compositional change of the outlet gas was detected with a catalyst analyzer (“Belcat-A”, available from Microtrac-Bel Japan Co., Ltd.) equipped with a thermal conductivity detector (TCD).

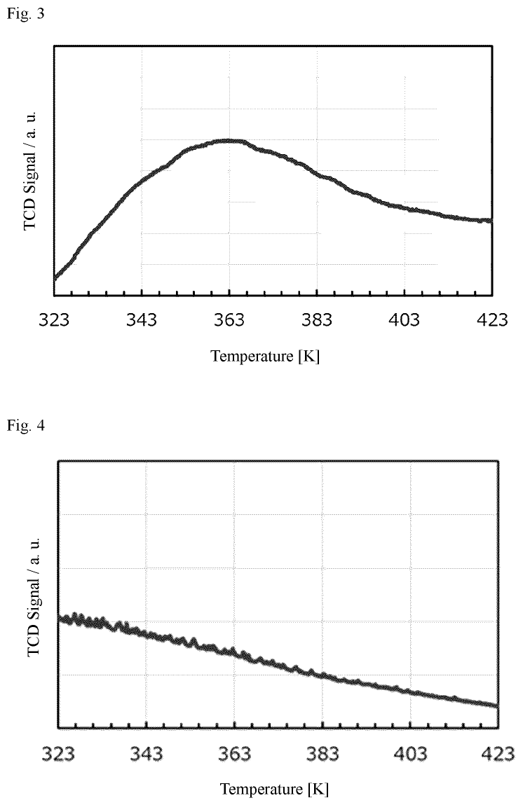

FIGS. 3 and 4 show the temporal change of the signal from the detector in each temperature.

FIG. 3 is the temperature-programmed desorption spectrum of carbon dioxide gas of the catalyst carrier of Example 1, and FIG. 4 is the temperature-programmed desorption spectrum of carbon dioxide gas of the catalyst carrier of Comparative Example 1.

In Example 1, the CO₂ gas adsorbed on the surface is released by heating, which appears as the temperature-programmed desorption peak in the change of the TCD signal. In Comparative Example 1, on the other hand, no desorption peak is observed, from which it is understood that carbon dioxide gas is not adsorbed. The results show that in the catalyst carrier of Example 1, an amino group is chemically carried on the surface of the carbon black through the method using diazo reaction.

### <Production of Catalyst>

### Example 1

An ethanol dispersion liquid containing 0.1 g of the catalyst carrier of Example 1 was irradiated with ultrasonic wave for 10 minutes, and then the dispersion liquid was allowed to stand in a vacuum chamber in a reduced pressure state of 10 kPa (absolute pressure) for 10 minutes. Subsequently, 11.7 mL of a 0.1 mol/L silver nitrate solution (metal ion supplier) and 1 mL of a 2.3 mol/L sodium phosphinate solution (reducing agent) were mixed with the dispersion liquid, and the mixture was agitated for 8 hours or more to reduce silver nitrate. After completing the reaction, the resulting slurry was rinsed with distilled water, and the solid matter was recovered with a centrifugal separator, and then vacuum-dried at 60° C. overnight, resulting in catalyst powder of Example 1.

### Examples 2 to 6 and Comparative Examples 1 to 3

Catalysts of Examples 2 to 6 and Comparative Examples 1 to 3 were produced in the same manner as in the production of the catalyst of Example 1 except that the catalyst carrier was changed from the catalyst carrier of Example 1 to any of the catalyst carriers of Examples 2 to 6 and Comparative Examples 1 to 3.

### <Solid Electrolyte Electrolysis Apparatus>

### Example 1

The catalyst powder of Example 1 was again dispersed in an ethanol solution, with which an anion exchange resin was mixed as the ionomer. The 1H-NMR measurement of the anion exchange resin in a dry state revealed that the base site density was calculated as 2.8 mmol/cm³ from the integral value of the signal. The anion exchange resin is a fluorene based resin having an aromatic ring as a substrate on the main chain and a quaternary ammonium group as a side chain (quaternary alkylamine group) bonded to the main chain.

After mixing, the dispersion liquid was irradiated with ultrasonic wave for 10 minutes, and then allowed to stand in a vacuum chamber in a reduced pressure state of 10 kPa (absolute pressure) for 10 minutes. The dispersion liquid was coated on carbon paper with a spray coater to provide a cathode. The cathode had the coated film of the dispersion liquid as a catalyst layer, and the carbon paper as a gas diffusion layer.

The cathode was adhered with the anion exchange membrane having a thickness of approximately 30 μm (base site density: 2.8 mmol/cm³), and an anode produced by supporting iridium oxide on a titanium mesh (available from Taiyo Wire Cloth Co., Ltd., aperture ratio: 56%), so as to provide an ion exchange membrane-electrode assembly.

The anode had a structure in contact with an electrolytic solution (KHCO₃ solution of 0.5 mol/L) tank.

### Examples 2 to 6 and Comparative Examples 1 to 3

Solid electrolyte electrolysis apparatuses of Examples 2 to 6 and Comparative Examples 1 to 3 were produced in the same manner as in the production of the solid electrolyte electrolysis apparatus of Example 1 except that the catalyst powder was changed from the catalyst powder of Example 1 to any of the catalyst powder of Examples 2 to 6 and Comparative Examples 1 to 3.

### <Evaluation of Solid Electrolyte Electrolysis Apparatus>

In each of the solid electrolyte electrolysis apparatuses of Examples 1 to 6 and Comparative Examples 1 to 3, CO₂ was electrolyzed by supplying pure CO₂ to the cathode with an applied potential of the cathode set to −1.8 V with respect to the silver/silver chloride reference electrode, and the CO formation current density (mA/cm²) in forming CO was measured.

The results are shown in Table 1.

TABLE 1

| | Co formation current |
|---|---|
| | density (mA/cm²) |
| Example 1 | 200 |
| Example 2 | 190 |
| Example 3 | 130 |
| Example 4 | 140 |
| Example 5 | 150 |
| Example 6 | 145 |
| Comparative Example 1 | 110 |
| Comparative Example 2 | 55 |
| Comparative Example 3 | 95 |

It is understood from Table 1 that the cases where the surface is modified with a group containing a primary amino group and a triazine ring (Examples 1 to 3) and the cases where the surface is modified with a group containing a primary amino group and a pyrimidine ring (Examples 4 and 5) show higher CO formation current densities than the case where the surface was not modified (Comparative Example 1). On the other hand, the cases where surface is modified with a group containing no nitrogen-containing heterocyclic ring (Comparative Examples 2 and 3) show further lower CO formation current densities. It is estimated that the surface modification of the carrier according to the present embodiment with a nitrogen-containing heteroaryl group having a primary amino group provides an effect of enhancing the CO₂ reduction reaction rate through the appropriate CO₂ adsorption function.

### INDUSTRIAL APPLICABILITY

In the solid electrolyte electrolysis apparatus according to the present embodiment, for example, CO₂ gas emitted from factories is used as a raw material, and renewable energy, such as solar battery, to the voltage application unit is used, whereby a synthetic gas containing at least CO and H₂ at a desired formation ratio can be produced. The synthetic gas produced in this manner can produce fuel substrates, chemical raw materials, and the like through the measures, such as FT synthesis (Fischer-Tropsch synthesis) or methanation.

### REFERENCE SIGN LIST

10: gas diffusion layer
20: catalyst layer
22: ionomer
24: catalyst
30: solid electrolyte (ion exchange membrane)
40: anode
50: ion exchange membrane-electrode assembly
100: cathode collector
200: cathode
300: solid electrolyte (ion exchange membrane)
400: anode
500: anode collector
600: electrolytic solution
700: voltage application unit
800: solid electrolyte electrolysis apparatus

1. A catalyst, comprising:
fine particles selected from the group consisting of gold, silver, copper, nickel, iron, cobalt, zinc, chromium, palladium, tin, manganese, aluminum, indium, bismuth, molybdenum, and carbon nitride, or a metal complex comprising a metal selected from the group consisting of copper, nickel, iron, cobalt, zinc, manganese, molybdenum, and aluminum, or an ion of the metal, having a ligand coordinated thereto; and
a carrier comprising carbon,
wherein the carrier has on a surface thereof a nitrogen-containing heteroaryl group having a primary amino group.

2. The catalyst of claim 1, wherein the nitrogen-containing heteroaryl group has a cyclic structure represented by formula (1) 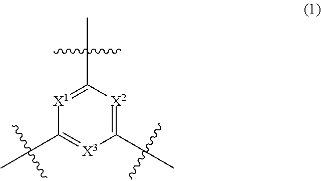
wherein
X¹ to X³ each independently represent a carbon atom or a nitrogen atom, in which at least one of X¹ to X³ represents a nitrogen atom, and in the case where X¹ to X³ represent carbon atoms, the carbon atom has a hydrogen atom or a primary amino group.

3. The catalyst of claim 1, wherein the nitrogen-containing heteroaryl group is represented by formula (2) 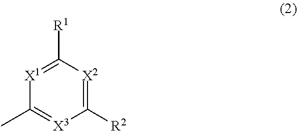
wherein
X¹ to X³ each independently represent a carbon atom or a nitrogen atom, in which at least one of X¹ to X³ represents a nitrogen atom, and in the case where X¹ to X³ represent carbon atoms, the carbon atom has a hydrogen atom or a primary amino group, and
R¹ and R² each independently represent a primary amino group or a hydrocarbon group, and a primary amino group exists in formula (2).

4. The catalyst of claim 1, wherein the nitrogen-containing heteroaryl group has a cyclic structure represented by formula (4)

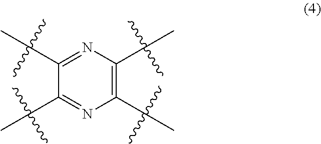 [SMILES: *c1nc(*)c(*)nc1*]

5. The catalyst of claim 1, wherein the nitrogen-containing heteroaryl group is represented by formula (5) 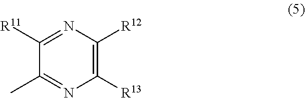
wherein
R¹¹ to R¹³ each independently represent a primary amino group, a hydrocarbon group, or a hydrogen atom, and
a primary amino group exists in formula (5).

6. A cathode, comprising:
a catalyst layer comprising the catalyst of claim 1; and
a gas diffusion layer.

7. An ion exchange membrane-electrode assembly, comprising:
the cathode of claim 6;
a solid electrolyte; and
an anode.

8. The ion exchange membrane-electrode assembly of claim 7, wherein the solid electrolyte is an anion exchange membrane.

9. A solid electrolyte electrolysis apparatus, comprising:
the cathode of claim 6;
an anode forming a pair of electrodes with the cathode;
a solid electrolyte intervening between the cathode and the anode, in a contact state; and
a voltage application unit applying a voltage between the cathode and the anode.

10. The solid electrolyte electrolysis apparatus of claim 9, wherein the solid electrolyte is an anion exchange membrane.

11. The catalyst of claim 2, wherein the nitrogen-containing heteroaryl group is represented by formula (2) 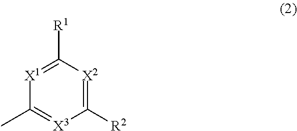
wherein X¹ to X³ each independently represent a carbon atom or a nitrogen atom, in which at least one of X¹ to X³ represents a nitrogen atom, and in the case where X¹ to X³ represent carbon atoms, the carbon atom has a hydrogen atom or a primary amino group, and
R¹ and R² each independently represent a primary amino group or a hydrocarbon group, and a primary amino group exists in formula (2).

12. The catalyst of claim 4, wherein the nitrogen-containing heteroaryl group is represented by formula (5) 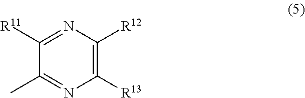
wherein R¹¹ to R¹³ each independently represent a primary amino group, a hydrocarbon group, or a hydrogen atom, and
a primary amino group exists in formula (5).

13. A cathode, comprising:
a catalyst layer comprising the catalyst of claim 2; and
a gas diffusion layer.

14. A cathode, comprising:
a catalyst layer comprising the catalyst of claim 3; and
a gas diffusion layer.

15. A cathode, comprising:
a catalyst layer comprising the catalyst of claim 4; and
a gas diffusion layer.

16. A cathode, comprising:
a catalyst layer comprising the catalyst of claim 5; and
a gas diffusion layer.

17. The solid electrolyte electrolysis of claim 13, wherein the solid electrolyte is an anion exchange membrane.

18. The solid electrolyte electrolysis apparatus of claim 14, wherein the solid electrolyte is an anion exchange membrane.

19. The solid electrolyte electrolysis apparatus of claim 15, wherein the solid electrolyte is an anion exchange membrane.

20. The solid electrolyte electrolysis apparatus of claim 16, wherein the solid electrolyte is an anion exchange membrane.
